(19) United States
(12) Patent Application Publication
(10) Pub. No.: US 2009/0291830 A1
(43) Pub. Date: Nov. 26, 2009

(54) HONEYCOMB STRUCTURE

(75) Inventors: Kazushige OHNO, Ibi-Gun (JP); Masafumi Kunieda, Ibi-Gun (JP); Takahiko Ido, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-Shi (JP)

(21) Appl. No.: 12/507,067

(22) Filed: Jul. 22, 2009

Related U.S. Application Data
(63) Continuation of application No. PCT/JP2008/059271, filed on May 20, 2008.

(51) Int. Cl. B01J 29/06; B01J 29/08; B01J 29/14

(52) U.S. Cl. 502/64; 502/60; 502/77; 502/79; 502/78; 502/74

(57) ABSTRACT

A honeycomb structure includes a center area, an outer peripheral area, and at least one honeycomb unit having a longitudinal direction. The center area has a smaller similarity shape in relation to a peripheral shape of the honeycomb structure in a cross section perpendicular to the longitudinal direction. The smaller similarity shape is defined by including a center of the honeycomb structure and substantially a half of a length from the center to the peripheral shape of the honeycomb structure. The outer peripheral area is located outside the smaller similarity shape. An aperture ratio of the honeycomb structure is from approximately 50% to approximately 65% in the cross section of the honeycomb structure. The aperture ratio includes a first aperture ratio in the outer peripheral area and a second aperture ratio in the center area. The first aperture ratio is larger than the second aperture ratio.

### CROSS-REFERENCE TO RELATED APPLICATIONS

The present application is a continuation of PCT/JP2008/059271 filed May 20, 2008, the entire contents of which are hereby incorporated herein by reference.

### BACKGROUND OF THE INVENTION

1. Field of the Invention

The present invention relates to a honeycomb structure.

2. Description of the Related Art

Conventionally, an SCR (Selective Catalytic Reduction) system capable of converting NOx into nitrogen and water using ammonia has been known as a system converting exhaust gas from vehicles (based on the following formulas).

4NO+4NH₃+O₂→4N₂+6H₂O

6NO₂+8NH₃→7N₂+12H₂O

NO+NO₂+2NH₃→2N₂+3H₂O

Further, in the SCR system, zeolite is a known material for adsorbing ammonia.

On the other hand, International Publication No. WO06/137149 discloses a honeycomb structure having a honeycomb unit including inorganic particles and at least one of inorganic fibers and whiskers, the inorganic particles being at least one selected from the group consisting of alumina, silica, zirconia, titania, ceria, mullite, and zeolite.

The entire contents of International Publication No. WO06/137149 are hereby incorporated herein by reference.

### SUMMARY OF THE INVENTION

According to an aspect of the present invention, a honeycomb structure includes at least one honeycomb unit having a longitudinal direction and including walls, zeolite, and an inorganic binder. The walls extend along the longitudinal direction to define through holes. The honeycomb structure includes a center area and an outer peripheral area. The center area has a smaller similarity shape in relation to a peripheral shape of the honeycomb structure in a cross section perpendicular to the longitudinal direction. The smaller similarity shape is defined by including a center of the honeycomb structure and substantially a half of a length from the center to the peripheral shape of the honeycomb structure. The outer peripheral area is located outside the smaller similarity shape. An aperture ratio of the honeycomb structure is from approximately 50% to approximately 65% in the cross section of the honeycomb structure. The aperture ratio includes a first aperture ratio in the outer peripheral area and a second aperture ratio in the center area. The first aperture ratio is larger than the second aperture ratio.

### BRIEF DESCRIPTION OF THE DRAWINGS

Other objects, features, and advantages of the present invention will become more apparent from the following description when read in conjunction with the accompanying drawings, in which:

FIG. 1A is a perspective view showing an exemplary honeycomb structure according to an embodiment of the present invention;

FIG. 1B is an enlarged view of a cross section of the honeycomb structure in FIG. 1A, the cross section being cut in the direction perpendicular to a longitudinal direction of the honeycomb structure;

FIG. 1C is a schematic view of a cross section of the honeycomb structure in FIG. 1A;

FIG. 2A is a schematic view of another example of a cross section of a honeycomb structure according to an embodiment of the present invention, the cross section being cut in the direction perpendicular to the longitudinal direction of the honeycomb structure;

FIG. 2B is a schematic view of still other example of a cross section of a honeycomb structure according to an embodiment of the present invention, the cross section being cut in the direction perpendicular to the longitudinal direction of the honeycomb structure;

FIG. 3A is a perspective view showing other example of a honeycomb structure according to an embodiment of the present invention;

FIG. 3B is a perspective view showing a honeycomb unit of the honeycomb structure in FIG. 3A; and

FIG. 4 is a drawing illustrating a method of measuring NOx conversion rate.

### DESCRIPTION OF THE EMBODIMENT

Embodiments will now be described with reference to the accompanying drawings, wherein like reference numerals designate corresponding or identical elements throughout the various drawings.

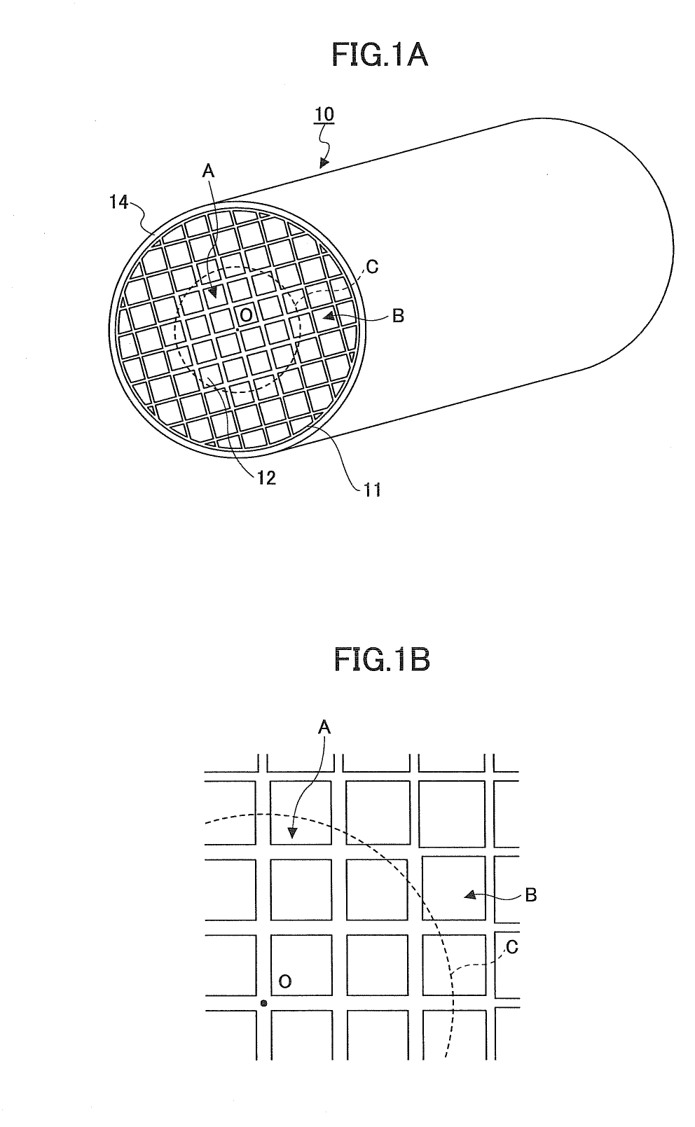

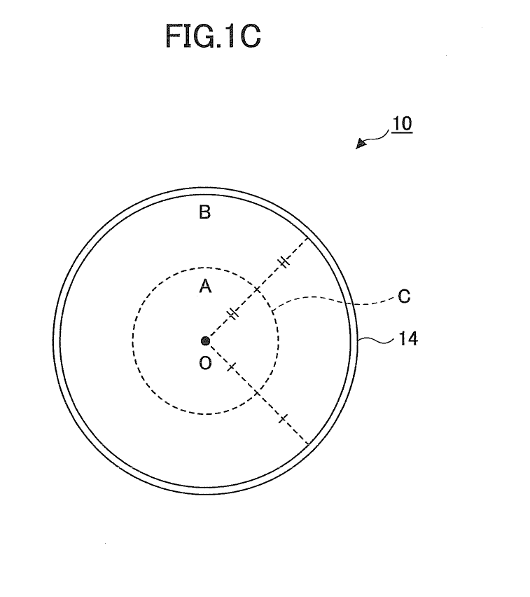

FIGS. 1A, 1B, 1C show an example of a honeycomb structure 10 according to an embodiment of the present invention. More specifically, FIG. 1A is a perspective view of the honeycomb structure 10; FIG. 1B is an enlarged view of a cross section of the honeycomb structure in FIG. 1A, the cross section being cut in the direction perpendicular to the longitudinal direction of the honeycomb structure; and FIG. 1C is a schematic view of the cross section the of the honeycomb structure in FIG. 1A. The honeycomb structure 10 includes a single honeycomb unit 11 and an outer peripheral coating layer 14. The honeycomb unit 11 includes zeolite and inorganic binder and has a shape in which plural through holes 12 separated from each other by partition walls extend along the longitudinal direction of the honeycomb structure 10. The outer peripheral coating layer 14 is formed on an outer surface of the honeycomb unit 11, the outer surface being extended along the longitudinal direction of the honeycomb structure 10. In this configuration, the aperture ratio (opening ratio) of the honeycomb unit 11 at a cross section perpendicular to the longitudinal direction of the honeycomb structure 10 is in a range from approximately 50% to approximately 65%, and preferably in a range from approximately 55% to approximately 60%. Further, when the cross section of the honeycomb structure 10 excluding the outer peripheral coating layer 14, i.e., the cross section of the honeycomb unit 11, is divided into substantially two parts, a center area “A” and an outer peripheral area “B”, so that each point of the boundary dividing the two parts is equidistant from both the center of the cross section and the outer peripheral of the cross section, the cross section being perpendicular to the longitudinal direction of the honeycomb structure 10, the aperture ratio of the outer peripheral area “B” is greater than that of the center area “A”. Herein, the boundary dividing the center area “A” and the outer peripheral area “B” is called the boundary line “C” (see FIG. 1A). The honeycomb structure according to an embodiment of the present invention may include an outer peripheral coating layer on the peripheral surface. The term aperture ratio herein refers to an aperture ratio of the honeycomb structure excluding the outer peripheral coating layer when the honeycomb structure includes the outer peripheral coating layer. On the other hand, when the honeycomb structure does not include the outer peripheral coating layer, the term aperture ratio herein refers to an aperture ratio of the honeycomb structure. In the same manner, the terms the center area and the outer peripheral area are defined in the honeycomb structure excluding the outer peripheral coating layer when the honeycomb structure includes the outer peripheral coating layer. On the other hand, when the honeycomb structure does not include the outer peripheral coating layer, the terms the center area and the outer peripheral area are defined in the honeycomb structure. When the honeycomb structure 10 is used in an SCR system (such as an urea SCR system), more exhaust gas is likely to flow through not only the center area “A” but also the outer peripheral area “B”. As a result, ammonia adsorbed by zeolite in the outer peripheral area “B” is more likely to be effectively used for NOx conversion, thereby more easily improving the NOx conversion rate.

When the aperture ratio of the cross section perpendicular to the longitudinal direction of the honeycomb unit 11 is equal to or more than approximately 50%, a specific surface area of the honeycomb unit 11 is unlikely to become smaller and the partition walls is unlikely to become thicker. As a result, the chances of contact of the ammonia adsorbed by zeolite with NOx are unlikely to be reduced and therefore, zeolite can be more effectively used for the NOx conversion. On the other hand, when the aperture ratio of the cross section perpendicular to the longitudinal direction of the honeycomb unit 11 is equal to or less than approximately 65%, the strength of the honeycomb unit 11 is unlikely to become insufficient.

In the following, the honeycomb structure 10 is described in more detail. As shown in FIGS. 1A through 1C, the honeycomb unit 11 includes the center area “A” and the outer peripheral area “B” divided by the boundary line “C”. In this case, each point on the boundary line “C” is substantially equidistant from both the center of the cross section and the outer peripheral of the cross section, the cross section being perpendicular to the longitudinal direction of the honeycomb unit 11. Because of this feature, the boundary line “C” has a shape substantially similar to that of the outer peripheral of the honeycomb unit 11. Further, the thickness of the partition walls in the center area “A” is greater than that in the outer peripheral area “B”. In each of the same areas, the thickness of the partition walls (excluding the walls crossing the boundary line “C”) is substantially constant. In this case, the thickness of the partition walls crossing the boundary line “C” is the same as that of the partition walls in the center area “A”.

The aperture ratios of the center area “A” and the outer peripheral area “B” may be obtained based on the corresponding areas excluding the through holes 12 and the partition walls that are crossing the boundary line “C”.

In a honeycomb structure 10 according to an embodiment of the present invention, the thickness of the partition walls may change continuously or discontinuously in each of the center area “A” and the outer peripheral area “B”. In a case where the thickness of the partition walls changes in the center area “A”, it is preferable that the closer the partition wall is located to the center of the honeycomb structure 10, the thicker the partition wall becomes to make it easier to flow exhaust gas through the outer side area. Further, in a case where the thickness of the partition walls changes in the outer peripheral area “B”, it is preferable that the closer the partition wall is located to the outer peripheral of the honeycomb structure 10, the thinner the partition wall becomes to make it easier to flow exhaust gas through the outer side area.

Further, in the honeycomb structure 10 according to an embodiment of the present invention, the thickness of the partition walls may be constant as long as the aperture ratio of the outer peripheral area “B” is greater than that of the center area “A”. In this case, the density of the through holes 12 of the center area “A” is greater than that of the outer peripheral area “B”.

The aperture ratio of the center area “A” is preferably in a range from approximately 50% to approximately 60%, and more preferably in a range from approximately 55% to approximately 60%. If the aperture ratio of the center area “A” is equal to or more than approximately 50%, the specific surface area of the honeycomb unit 11 is unlikely to become smaller, resulting in that the chances of contact of the ammonia adsorbed by zeolite with NOx may be unlikely to be reduced, and the partition walls is unlikely to become thicker, resulting in that zeolite in the center area “A” may more likely to be effectively used for the NOx conversion.

On the other hand, when the aperture ratio of the of the center area “A” is equal to or less than approximately 60%, exhaust gas becomes more unlikely to flow through the center area “A” and therefore, the zeolite in the outer peripheral area “B” may be more likely to be more effectively used for NOx conversion.

The aperture ratio of the outer peripheral area “B” is preferably in a range from approximately 55% to approximately 65%, and more preferably in a range from approximately 60% to approximately 65%. If the aperture ratio of the outer peripheral area “B” is equal to or more than approximately 55%, it becomes more unlikely to concentrate the flow of exhaust gas passing though the center area “A”, resulting in that zeolite in the outer peripheral area “B” may become more effectively used for the NOx conversion. On the other hand, if the aperture ratio of the outer peripheral area “B” is equal to or less than approximately 65%, the strength of the honeycomb unit 11 is unlikely to become insufficient.

The ratio of the aperture ratio of the outer peripheral area “B” to the aperture ratio of the center area “A” is preferably in a range from approximately 1.2 to approximately 2.0. If the ratio of those two aperture ratios is equal to or more than approximately 1.2, it becomes more unlikely to concentrate the flow of exhaust gas passing though the center area “A”, resulting in that zeolite in the outer peripheral area “B” may be more effectively used for the NOx conversion. On the other hand, if the ratio of those two aperture ratios is equal to or less than approximately 2.0, the strength of the honeycomb structure 10 is unlikely to become insufficient.

In the honeycomb unit 11, zeolite content per apparent volume is preferably in a range from approximately 230 g/L to approximately 270 g/L. If the zeolite content per apparent volume is equal to or more than approximately 230 g/L, it becomes not necessary to increase the apparent volume to obtain sufficient NOx conversion rate. On the other hand, if the zeolite content per apparent volume is equal to or less than approximately 270 g/L, the strength of the honeycomb unit 11 is unlikely to become insufficient. Herein, the apparent volume of the honeycomb unit refers to a volume including the through holes.

The zeolite may include but is not limited to β-type zeolite, Y-type zeolite, ferrierite, ZSM-5 type zeolite, mordenite, faujasite, zeolite A, zeolite L, and any combination thereof.

Preferably, in zeolite, the mole ratio of silica to alumina is in a range from approximately 30 to approximately 50.

Further, to enhance ammonia adsorption, zeolite may be ion-exchanged. The cationic species to be ion-exchanged include but are not limited to Fe, Cu, Ni, Co, Zn, Mn, Ti, Ag, V and the like and any combination thereof. The ion-exchanged amount is preferably in a range from approximately 1.0 wt % to approximately 10.0 wt %, and more preferably in a range from approximately 1.0 wt % to approximately 5.0 wt %. If the ion-exchanged amount is equal to or more than approximately 1.0 wt %, the enhancement of ammonia adsorption by the ion-exchange is unlikely to become insufficient. On the other hand, if the ion-exchanged amount is equal to or less than approximately 10.0 wt %, the structure is unlikely to become deformable upon being heated. To perform the ion-exchange with zeolite, zeolite may be dipped in water solution including the cation species.

Further, preferably, zeolite includes secondary particles. The average particle diameter of the secondary particles of the zeolite is preferably in a range from approximately 0.5 μm to approximately 10 μm. If the average particle diameter of the secondary particles of the zeolite is equal to or more than approximately 0.5 μm, it become unnecessary to add a large amount of inorganic binder, resulting in that it may become easy to perform extrusion molding of the honeycomb unit 11. On the other hand, if the average particle diameter of the secondary particles of the zeolite is equal to or less than approximately 10 μm, the specific surface area of zeolite is unlikely to become smaller, resulting in that the NOx conversion rate is unlikely to be reduced.

Further, to reinforce the strength of the honeycomb unit 11, inorganic particles other than zeolite may be further added to the honeycomb unit 11. The inorganic particles other than zeolite may include but are not limited to alumina, silica, titania, zirconia, ceria, mullite, a precursor of one of the compounds, and any combination thereof. Among them, particularly, alumina, or zirconia may be more preferably used.

The average particle diameter of the inorganic particles other than zeolite is preferably in a range from approximately 0.5 μm to approximately 10 μm. If the average particle diameter of the inorganic particles other than zeolite is equal to or more than approximately 0.5 μm, it becomes unnecessary to add a large amount of inorganic binder, resulting in that it may become easy to perform extrusion molding of the honeycomb unit 11. On the other hand, if the average particle diameter of the inorganic particles other than zeolite is equal to or less than approximately 10 μm, the effect of enhancing the strength of the honeycomb unit 11 is unlikely to become insufficient. The inorganic particles other than zeolite may include secondary particles.

Further, the ratio of the average particle diameter of the secondary particles of zeolite to the average particle diameter of the secondary particles of inorganic particles other than zeolite is preferably equal to or less than approximately 1 and more preferably in a range from approximately 0.1 to approximately 1. If this ratio is equal to or less than approximately 1, the effect of enhancing the strength of the honeycomb unit 11 is unlikely to become insufficient.

The content of the inorganic particles other than zeolite in the honeycomb unit 11 is preferably in the range of approximately 3 wt % to approximately 30 wt %, and more preferably in the range of approximately 5 wt % to approximately 20 wt %. If this content is equal to more than approximately 3 wt %, the effect of enhancing the strength of the honeycomb unit 11 is unlikely to become insufficient. On the other hand, if this content is equal to or less than approximately 30 wt %, the content of zeolite in the honeycomb unit 11 is unlikely to be reduced, which is unlikely to reduce the NOx conversion rate.

As the inorganic binder, solid content including but not limited to alumina sol, silica sol, titania sol, water glass, sepiolite, attapulgite, and any combination thereof may be used.

The content of inorganic binder in the honeycomb unit 11 is preferably in a range from approximately 5 wt % to approximately 30 wt %, and more preferably in a range from approximately 10 wt % to approximately 20 wt %. If the content of inorganic binder is equal to or more than approximately 5 wt %, the strength of the honeycomb unit 11 is unlikely to be reduced, and if the content of inorganic binder is equal to or less than approximately 30 wt %, it is unlikely to become difficult to mold the honeycomb unit 11.

To enhance the strength of the honeycomb unit 11, preferably, the honeycomb unit 11 further includes inorganic fibers.

As the inorganic fibers, any material as long as it can enhance the strength of the honeycomb unit 11 may be used. However, preferably, inorganic fibers may be but are not limited to alumina, silica, silicon carbide, silica-alumina, glass, potassium titanate, aluminum borate, and any combination thereof.

The aspect ratio of the inorganic fibers is preferably in a range from approximately 2 to approximately 1000, more preferably in a range from approximately 5 to approximately 800, and still more preferably in the range from approximately 10 to approximately 500. If the aspect ratio of the inorganic fibers is equal to or more than approximately 2, the effect of enhancing the strength of the honeycomb unit 11 is unlikely to be reduced. On the other hand, when the aspect ratio of the inorganic fibers is equal to or less than approximately 1000, clogging or the like is unlikely to occur during molding of the honeycomb unit 11 such as extrusion molding. Further, inorganic fibers are unlikely to be broken during the molding of the honeycomb unit 11, thereby making it difficult to reduce the effect of enhancing the strength of the honeycomb unit 11.

The content of inorganic fibers in the honeycomb unit 11 is preferably in a range from approximately 3 wt % to approximately 50 wt %, more preferably in a range from approximately 3 wt % to approximately 30 wt %, and still more preferably in the range from approximately 5 wt % to approximately 20 wt %. If the content of inorganic fibers is equal to or more than approximately 3 wt %, the effect of enhancing the strength of the honeycomb unit 11 is unlikely to be reduced, and if the content of inorganic fibers is equal to or less than approximately 50 wt %, zeolite content in the honeycomb unit 11 is unlikely to be reduced, which is unlikely to reduce the NOx conversion rate.

In the honeycomb unit 11, the density of the through holes 12 on a cross section surface perpendicular to the longitudinal direction of the honeycomb unit 11 is preferably in the range of approximately 15.5 units/cm² to approximately 124 units/cm², and more preferably in the range of approximately 31 units/cm² to approximately 93 units/cm². If the density of the through holes 12 is equal to or more than approximately 15.5 units/cm², it may become easy to have contact between exhaust gas and zeolite, thereby making it difficult to reduce the NOx conversion rate of the honeycomb unit 11. On the other hand, if the density of the through holes 12 is equal to or less than approximately 124 units/cm², a pressure loss of the honeycomb unit 11 is unlikely to be increased.

The thickness of the partition walls separating the through holes 12 from one another in the honeycomb unit 11 is preferably in a range from approximately 0.10 mm to approximately 0.50 mm, and more preferably in a range from approximately 0.15 mm to approximately 0.35 mm. If the thickness of the partition walls is equal to or more than approximately 0.10 mm, the strength of the honeycomb unit 11 is unlikely to be reduced, and if the thickness of the partition walls is equal to or less than approximately 0.50 mm, it may become easy to introduce exhaust gas into inside of the partition walls and therefore, zeolite in the partition walls is likely to be effectively used for converting NOx.

The thickness of the outer peripheral coating layer 14 is preferably in a range from approximately 0.1 mm to approximately 2 mm. If the thickness of the outer peripheral coating layer 14 is equal to or more than approximately 0.1 mm, the effect of enhancing the strength of the honeycomb structure 10 is unlikely to become insufficient, and if the thickness is equal to or less than approximately 2 mm, the zeolite content per volume in the honeycomb structure 10 is unlikely to be reduced and therefore, the NOx conversion rate of the honeycomb structure 10 is unlikely to be reduced.

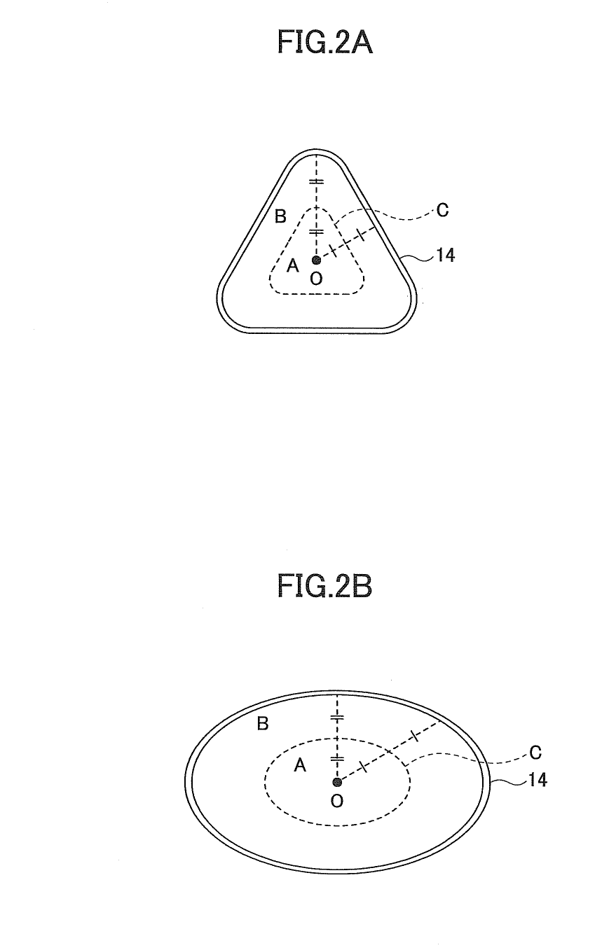

As shown in FIG. 1A, the shape of the honeycomb structure 10 is cylindrical. However, the shape of the honeycomb structure according to an embodiment of the present invention is not limited to this shape. For example, the honeycomb unit may have a shape such as a substantially triangular pillar shape (see FIG. 2A) and a substantially cylindroid shape (see FIG. 2B).

Further, the shape of the through hole 12 is an quadrangular pillar shape. However, the shape of the through hole 12 according to an embodiment of the present invention is not limited to this shape. For example, the through hole 12 may have a shape such as a substantially triangular pillar and a substantially hexagonal prism shape.

Next, an exemplary method of manufacturing the honeycomb structure 10 is described. First, molding such as extrusion molding is performed using raw material paste including zeolite and inorganic binder and further including, when necessary, inorganic particles other than zeolite, inorganic fibers and the like to form a raw honeycomb molded body having a cylindrical shape in which a plurality of through holes 12 extends in the direction parallel to the longitudinal direction of the honeycomb molded body and the through holes 12 are separated from each other by the interposing partition walls. By doing this, the honeycomb unit 11 having sufficient strength may be obtained even if the firing temperature is low. In this case, by changing the structure of a die for molding of the honeycomb unit 11, more specifically, by changing (adjusting) the thickness of the partition walls, the density of the through holes 12 and the like, it becomes possible to adjust the aperture ratio of the honeycomb unit 11.

As the inorganic binder, alumina sol, silica sol, titania sol, water glass, sepiolite, attapulgite and the like and any combination thereof may be added to the raw material paste.

Further, when necessary, organic binder, dispersion medium, molding aid and the like may be adequately added to the raw material paste.

The organic binder may be but is not limited to methylcellulose, carboxymethylcellulose, hydroxyethelcellulose, polyethyleneglycol, phenol resin, epoxy resin and the like and any combination thereof. The additive amount of the organic binder is preferably in a range from approximately 1 wt % to approximately 10 wt % with respect to the total weight of the compound including zeolite, inorganic particles other than zeolite, inorganic fibers, and inorganic binder.

The dispersion medium may be but is not limited to water, organic solvent such as benzene, alcohol such as methanol and the like and any combination thereof.

The molding aid may be but is not limited to ethylene glycol, dextrin, fatty acid, fatty acid soap, polyalcohol and the like and any combination thereof.

In preparing the raw material paste, it is preferable that the raw material paste be mixed and kneaded. An apparatus such as a mixer or an attritor may be used for the mixing, and an apparatus such as a kneader may be used for the kneading.

Next, the obtained honeycomb molded body is dried by using a drying apparatus such as a microwave drying apparatus, a hot air drying apparatus, a dielectric drying apparatus, reduced pressure drying apparatus, vacuum drying apparatus, and a freeze drying apparatus.

Further, the obtained honeycomb molded body is degreased. The degreasing conditions are not specifically limited and is are be selected in accordance with a kind or amount of organic substance included in the honeycomb molded body, but are preferably heating at a temperature of approximately 400° C. for approximately two hours.

Next, by firing the obtained honeycomb molded body, the honeycomb unit 11 having a cylindrical shape is obtained. The firing condition is not specifically limited but is preferably in the range from approximately 600° C. to approximately 1200° C., and more preferably in the range from approximately 600° C. to approximately 1000° C. If the firing temperature is equal to or more than approximately 600° C., the sintering is likely to progress, thereby making it difficult to reduce the strength of the honeycomb unit 11. On the other hand, if the firing temperature is equal to or less than approximately 1200° C., excessive sintering is unlikely to occur, and the reaction sites of zeolite is unlikely to be reduced.

Next, a paste for forming the outer peripheral coating layer 14 is applied to the outer side surface of the cylindrical honeycomb unit 11. As the paste for the outer peripheral coating layer 14, a mixture of inorganic binder and inorganic particles, a mixture of inorganic binder and inorganic fibers, a mixture of inorganic binder, inorganic particles and inorganic fibers, or the like may be used, but the paste is not limited to those.

Further, organic binder may also be added to the paste for forming the outer peripheral coating layer. The organic binder may include but is not limited to polyvinyl alcohol, methylcellulose, ethylcellulose, carboxymethylcellulose, and any combination thereof. Among those organic binders, more preferably, carboxymethylcellulose is used.

Next, the honeycomb unit 11 to which the paste for the outer peripheral coating layer 14 is applied is dried and solidified to obtain the cylindrical honeycomb structure 10. In this case, when organic binder is included in the paste for the outer peripheral coating layer 14, preferably the obtained honeycomb molded body is degreased. The degreasing conditions are not specifically limited and are to be selected in accordance with a kind or amount of organic substance, but are preferably heating at a temperature of approximately 700° C. for approximately twenty minutes.

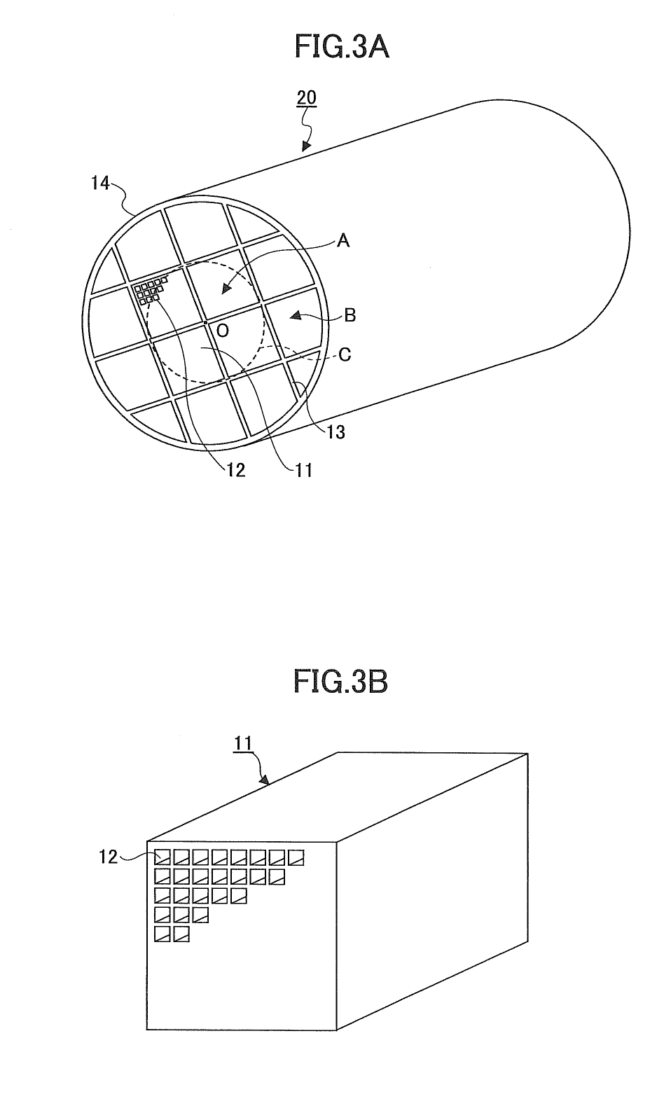

FIGS. 3A and 3B show other example of a honeycomb structure 20 according to other embodiment of the present invention. The honeycomb structure 20 is the same as the honeycomb structure 10 except that the honeycomb structure 20 includes plural of the honeycomb units 11 bonded to each other by intervening adhesive layers 13, each honeycomb unit 11 having a shape in which plural of the through holes 12 are extending in the direction parallel to the longitudinal direction of the structure 20 and separated from each other by the interposing partition walls.

A cross-sectional area perpendicular to the longitudinal direction of the honeycomb unit 11 is preferably in a range of approximately 5 cm² to approximately 50 cm². If the cross-sectional area is equal to or more than approximately 5 cm², the specific surface area of the honeycomb structure 10 is unlikely to be reduced and also the pressure loss of the honeycomb structure 10 is unlikely to be increased. On the other hand, if the cross-sectional area is equal to or less than approximately 50 cm², the strength against the thermal stress produced in the honeycomb unit 11 is unlikely to become insufficient.

The thickness of the adhesive layer 13 for bonding the honeycomb units 11 is preferably in a range from approximately 0.5 mm to approximately 2 mm. If the thickness of the adhesive layer 13 is equal to or more than approximately 0.5 mm, the bonding strength is unlikely to become insufficient. On the other hand, if the thickness of the adhesive layer 13 is equal to or less than approximately 2 mm, the specific surface area of the honeycomb structure 10 is unlikely to be reduced and the pressure loss of the honeycomb structure 10 is unlikely to be increased.

In FIGS. 3A and 3B, each honeycomb unit 11 has a quadrangular pillar shape. However, the shape of the honeycomb unit 11 according to an embodiment of the present invention is not limited to this shape. For example, the honeycomb unit 11 may have any shape such as a substantially hexagonal pillar shape as long as plural honeycomb units 11 may be easily bonded to each other.

Next, an exemplary method of manufacturing the honeycomb structure 20 is described. First, similar to the method of manufacturing the honeycomb unit 11 of the honeycomb structure 10, plural of the honeycomb units 11 having a quadrangular pillar shape are manufactured. In this case, the honeycomb units 11 for the center area “A”, outer peripheral area “B”, and the area including the boundary line “C” are manufactured. In this embodiment of the present invention, as the honeycomb units 11 for the area crossing the boundary line “C”, the honeycomb units 11 for the center area “A” and/or the honeycomb units 11 for outer peripheral area “B” may be used.

Next, an adhesive paste is applied to the outer side surface of the honeycomb units 11 to bond the honeycomb units 11 one by one and the bonded honeycomb units 11 are dried and solidified to form an assembly of the honeycomb units 11. The formed assembly of the honeycomb units 11 is cut so that the assembly of the honeycomb units 11 has a cylindrical shape. Further, a polishing process may further be added. Otherwise, the honeycomb units 11 having a substantially fan-like and a substantially square shape are bonded to each other to form an assembly of honeycomb units 11 having a cylindrical shape.

The adhesive paste may include but is not limited to a mixture of inorganic binder and inorganic particles, a mixture of inorganic binder and inorganic fibers, a mixture of inorganic binder, inorganic particles and inorganic fibers, or the like.

The adhesive paste may further include organic binder. The organic binder may include but is not limited to polyvinyl alcohol, methylcellulose, ethylcellulose, carboxymethylcellulose, and any combination thereof.

Next, a paste for forming the outer peripheral coating layer 14 is applied to the outer side surface of the cylindrical assembly of the honeycomb units 11. The material of the paste for the outer peripheral coating layer 14 is not limited to but may be the same as or different from that of the adhesive paste. The composition of the paste for the outer peripheral coating layer 14 may be the same as that of the adhesive paste.

Next, the assembly of the honeycomb units 11 to which the paste for the outer peripheral coating layer 14 is applied is dried and solidified to obtain the honeycomb structure 20 having a cylindrical shape. In this case, when organic binder is added to the paste for the outer peripheral coating layer 14 and/or the adhesive paste, preferably the obtained honeycomb structure 20 is degreased. The degreasing conditions are not specifically limited and are to be selected in accordance with a kind or amount of organic substance, but are preferably heating at a temperature of approximately 700° C. for approximately twenty minutes.

Further, the honeycomb structures 10 and 20 may be manufactured in a manner so that after the honeycomb structure is manufactured out of a raw material paste in which zeolite has not been ion-exchanged, the manufactured honeycomb structure is dipped in water solution including cation species so that the zeolite is ion-exchanged.

However, when a conventional honeycomb structure according to International Publication No. WO06/137149 using zeolite as a main material is used in the SCR system, most of exhaust gas flows through the center part of the honeycomb structure. Therefore, ammonia adsorbed to zeolite in the outer peripheral part of the honeycomb structure cannot effectively be used for NOx conversion, resulting in an insufficient NOx conversion rate.

The present invention is made in light of the above-described circumstances and may provide a honeycomb structure capable of improving the NOx conversion rate.

### EXAMPLES

### Example 1

First, 2,250 g of β-type zeolite (ion-exchanged by 3 wt % of Cu, average particle diameter: 2 μm, mol ratio of silica to alumina: 40), 2,600 g of alumina sol (solid content: 20 wt %) as inorganic binder component, 550 g of γ-alumina (average particle diameter: 2 μm) as inorganic particles, 780 g of alumina fibers (average fiber diameter: 6 μm; average fiber length: 100 μm) as inorganic fibers, and 410 g of methylcellulose as organic binder were mixed and kneaded to obtain a raw material paste. The zeolite particles were ion-exchanged with Cu by being impregnated in copper nitrate water solution. The ion-exchanged zeolite amount was measured by IPC emission spectroscopic analysis using an ICPS-8100 (ICP emission spectrometer by SHIMADZU Corporation). Then, the raw material paste was extrusion molded by using an extrusion molding apparatus to obtain a raw honeycomb molded body having a cylindrical shape. Next, the raw honeycomb molded body was dried by using a microwave drying apparatus and a hot air drying apparatus, and degreased at a temperature of 400° C. for five hours and then fired at a temperature of 700° C. for five hours to obtain the honeycomb unit 11 having a cylindrical shape, a diameter of 143 mm, and a length of 150 mm. In the obtained honeycomb structure, the aperture ratio of a cross section perpendicular to the longitudinal direction of the honeycomb structure was 60% and the zeolite content per apparent volume was 250 g/L.

Further, in the center area “A” of the honeycomb unit 11, an aperture ratio “X” of the cross section perpendicular to the longitudinal direction of the honeycomb unit 11 was 57%, the density of the through holes 12 was 65 units/cm², and the thickness of the partition walls was 0.3 mm. Further, in the outer peripheral area “B” of the honeycomb unit 11, an aperture ratio “Y” of the cross section perpendicular to the longitudinal direction of the honeycomb unit 11 was 61%, the density of the through holes 12 was 65 units/cm², and the thickness of the partition walls was 0.27 mm. In this case, the ratio of the aperture ratio “Y” to the aperture ratio “X” was 1.07 (see Table 1 below). The boundary line “C” defining the boundary between the center area “A” and the outer peripheral area “B” was a circle having a distance of 71.5 mm from the center “O” of the cross section perpendicular to the longitudinal direction of the honeycomb unit 11, and the thickness of the partition walls crossing the boundary line “C” was the same as the thickness of the partition walls in the center area “A”.

In this case, the aperture ratios “X” and “Y” were obtained by calculating the area of the through holes 12 of the center area “A” and the area of the outer peripheral area “B”, respectively, of the honeycomb structure using an optical microscope. Further, thicknesses of the partition walls of the center area “A” and the outer peripheral area “B” of the honeycomb structure were obtained by averaging (five samples of) the measured thicknesses of the partition walls of the center area “A” and the outer peripheral area “B”, respectively using an optical microscope. Further, the densities of the through holes 12 of the center area “A” and the outer peripheral area “B” of the honeycomb structure were obtained by counting the number of the through holes 12 of the center area “A” and the outer peripheral area “B”, respectively, of the honeycomb structure using an optical microscope.

Next, 29 parts by weight of γ-alumina (average particle diameter: 2 μm) as inorganic particles, 7 parts by weight of alumina fibers (average fiber diameter: 6 μm, average fiber length: 100 μm) as inorganic fibers, 34 parts by weight of alumina sol (solid content: 20 wt %) as inorganic binder, 5 parts by weight of methylcellulose as organic binder, and 25 parts by weight of water were mixed and kneaded to obtain the paste for the outer peripheral coating layer 14.

Further, after the paste for the outer peripheral coating layer 14 was applied to the outer side surface of the honeycomb unit 11 so that the thickness of the outer peripheral coating layer 14 become 0.4 mm, the honeycomb structure was dried and solidified by using a microwave drying apparatus and a hot air drying apparatus, and degreased at a temperature of 400° C. for two hours to obtain the honeycomb structure 10 having a cylindrical shape, a diameter of 143.8 mm, and a length of 150 mm.

### Examples 2 and 3, Comparative Example 1

The honeycomb structures having a cylindrical shape, a diameter of 143.8 mm and a length of 150 mm were manufactured in the same manner as in Example 1 except that the structure of the die of the extrusion molding apparatus was respectively changed (see Table 1).

TABLE 1

| | CENTER AREA “A” | | | OUTER PERIPHERAL AREA “B” | | | RATIO OF | |
|---|---|---|---|---|---|---|---|---|
| | | DENSITY | THICKNESS | | DENSITY | THICKNESS | APERTURE | |
| | APERTURE | OF | OF | APERTURE | OF | OF | RATIO “Y” | NOx |
| | RATIO | THROUGH | PARTITION | RATIO | THROUGH | PARTITION | TO | CONVERSION |
| | “X” | HOLES | WALLS | “Y” | HOLES | WALLS | APERTURE | RATE |
| | [%] | [UNITS/cm²] | [mm] | [%] | [UNITS/cm²] | [mm] | RATIO “X” | [%] |
| EXAMPLE 1 | 57 | 65 | 0.3 | 61 | 65 | 0.27 | 1.07 | 86 |
| EXAMPLE 2 | 54 | 76 | 0.3 | 62 | 76 | 0.24 | 1.15 | 87 |
| EXAMPLE 3 | 51 | 88 | 0.3 | 63 | 88 | 0.22 | 1.24 | 88 |
| EXAMPLE 4 | 51 | 88 | 0.3 | 63 | 47 | 0.25 | 1.24 | 88 |
| COMPARATIVE | 60 | 54 | 0.3 | 60 | 54 | 0.25 | 1.00 | 75 |
| EXAMPLE 1 | | | | | | | | |

### Example 4

Plural of the honeycomb units 11 each having a square pillar shape and size of 35 mm in height, 35 in width, and 150 mm in length were manufactured in the same manner as in Example 1. Then, a paste for the outer peripheral coating layer was applied to the outer side surfaces of the honeycomb units 11 and the honeycomb units 11 were bonded to each other and dried and solidified at a temperature of 120° C. to manufacture an assembly of the honeycomb units 11. Then, the assembly of the honeycomb units 11 was cut by using a diamond cutter so that the cut cross section is perpendicular to the longitudinal direction of the assembly and substantially symmetrical with respect to a point (point-symmetric) and the assembly has a diameter of 143 mm and a length of 150 mm. Further, the paste for the outer peripheral coating layer 14 used in Example 1 was applied to the outer side surface of the cut assembly of the honeycomb units 11 so that the thickness of the outer peripheral coating layer 14 become 0.4 mm. Then the assembly of the honeycomb units 11 was dried and solidified at a temperature of 120° C. by using a microwave drying apparatus and a hot air drying apparatus and degreased at a temperature of 400° C. for two hours to obtain the honeycomb structure 20 having a cylindrical shape, a diameter of 143.8 mm, and a length of 150 mm (see Table 1). The boundary line “C” defining the boundary between the center area “A” and the outer peripheral area “B” was a circle having a distance of 71.5 mm from the center “O” of the cross section perpendicular to the longitudinal direction of the honeycomb structure 20 excluding the outer peripheral coating layer 14, and the thickness of the partition walls crossing the boundary line “C” was the same as the thickness of the partition walls in the center area “A”.

### Measurement of NOx Conversion Rate

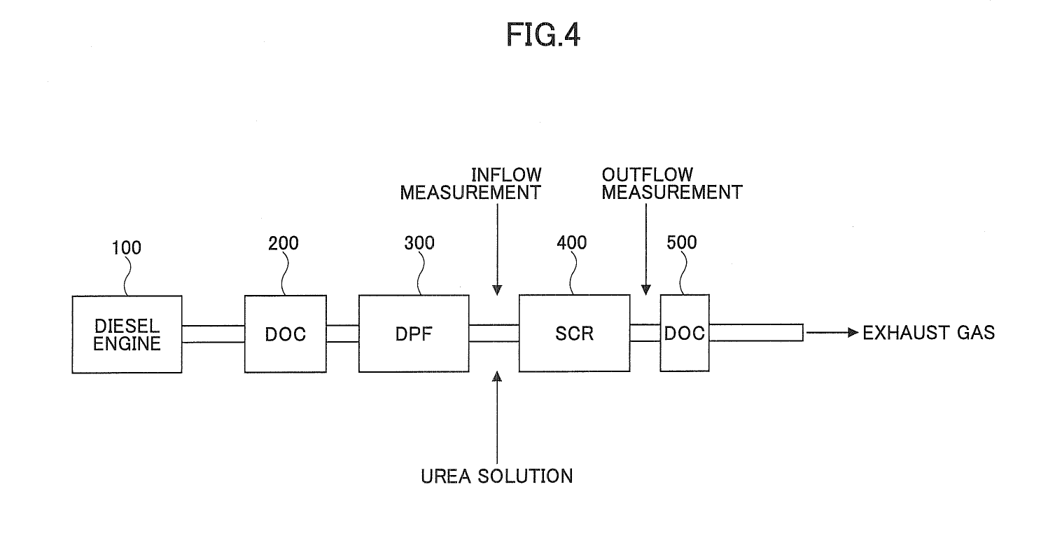

FIG. 4 shows a method of measuring NOx conversion rate. As shown in FIG. 4, a diesel engine (1.6 L direct injection engine) 100 is connected to a Diesel Oxidation Catalyst (DOC) 200, a Diesel Particulate Filter (DPF), an SCR 400, and a Diesel Oxidation Catalyst (DOC) 500 in series through exhaust pipes. In this configuration, the diesel engine 100 is operated at 3,000 rpm and 170 Nm torque, and a urea solution is injected into the exhaust pipe just before the SCR 400. Under this status, the amounts of nitric oxide (NO) and nitrogen dioxide (NO₂) flowing into the SCR 400 and flowing from the SCR 400 were measured by using MEXA-7500DEGR (exhaust analyzer by HORIBA LTD) and an NOx conversion rate [%] defined as in the following formula 1 was measured (detection limit: 0.1 ppm)

[{(inflow amount of NOx)−(outflow amount of NOx)}/(inflow amount of Nox)]×100 formula 1

In the configuration of FIG. 4, as the DOC 200, a honeycomb structure having a diameter of 143.8 mm, a length of 7.35 mm (available in market) with a sealing member (mat) disposed along its outer periphery housed in a metal shell was used. As the DPF 300, a honeycomb structure having a diameter of 143.8 mm, a length of 152.4 mm (available in market) with a sealing member (mat) disposed along its outer periphery housed in a metal shell was used. As the SCR 400, each of the honeycomb structures of Examples 1 through 4 and Comparative example 1 was used. As the DOC 500, a honeycomb structure having a diameter of 143.8 mm, a length of 50.8 mm (available in market) with a sealing member (mat) disposed along its outer periphery housed in a metal shell was used. The measurement results are shown in Table 1. As Table 1 shows, the NOx conversion rate of each of the honeycomb structures of Examples 1 through 4 is more superior than that of the honeycomb structure of Comparative example 1.

As described above, when a cross section perpendicular to the longitudinal direction of the honeycomb structure 10 is divided into two areas, i.e., the center area “A” and the outer peripheral area “B”, so that each point of a boundary line dividing the two areas is substantially equidistant from both the center of the cross section and the outer peripheral of the cross section, by making the aperture ratio of the outer peripheral area “B” greater than the aperture ratio of the center area “A”, it may become possible to improve the NOx conversion rate of the honeycomb structure 10.

Obviously, numerous modifications and variations of the present invention are possible in light of the above teachings. It is therefore to be understood that within the scope of the appended claims, the invention may be practiced otherwise than as specifically described herein.

What is claimed is:

1. A honeycomb structure comprising:
at least one honeycomb unit having a longitudinal direction and comprising:
walls extending along the longitudinal direction to define through holes;
zeolite; and
an inorganic binder;
a center area having a smaller similarity shape in relation to a peripheral shape of the honeycomb structure in a cross section perpendicular to the longitudinal direction, the smaller similarity shape being defined by including a center of the honeycomb structure and substantially a half of a length from the center to the peripheral shape of the honeycomb structure;
an outer peripheral area located outside the smaller similarity shape; and
an aperture ratio from approximately 50% to approximately 65% in the cross section of the honeycomb structure, the aperture ratio comprising a first aperture ratio in the outer peripheral area and a second aperture ratio in the center area, the first aperture ratio being larger than the second aperture ratio.

2. The honeycomb structure according to claim 1, wherein the first aperture ratio of the outer peripheral area is from approximately 55% to approximately 65%.

3. The honeycomb structure according to claim 1, wherein the second aperture ratio of the center area is from approximately 50% to approximately 60%.

4. The honeycomb structure according to claim 1, wherein a content of the zeolite per apparent volume in the at least one honeycomb unit is from approximately 230 g/L to approximately 270 g/L.

5. The honeycomb structure according to claim 1, wherein the zeolite comprises at least one of β-type zeolite, Y-type zeolite, ferrierite, ZSM-5 type zeolite, mordenite, faujasite, zeolite A, and zeolite L.

6. The honeycomb structure according to claim 1, wherein a mole ratio of silica to alumina in the zeolite is from approximately 30 to approximately 50.

7. The honeycomb structure according to claim 1, wherein the zeolite is ion-exchanged with at least one of Fe, Cu, Ni, Co, Zn, Mn, Ag, and V.

8. The honeycomb structure according to claim 1, wherein the zeolite comprises secondary particles having an average particle diameter from approximately 0.5 μm to approximately 10 μm.

9. The honeycomb structure according to claim 1, wherein the at least one honeycomb unit further comprises inorganic particles other than zeolite.

10. The honeycomb structure according to claim 9, wherein the inorganic particles other than zeolite comprise at least one of alumina, silica, titania, zirconia, ceria, mullite, and a precursor thereof.

11. The honeycomb structure according to claim 1, wherein the inorganic binder comprises a solid content of at least one of alumina sol, silica sol, titania sol, water glass, sepiolite, and attapulgite.

12. The honeycomb structure according to claim 1, wherein the at least one honeycomb unit further comprises inorganic fibers.

13. The honeycomb structure according to claim 12, wherein the inorganic fibers comprise at least one of alumina, silica, silicon carbide, silica-alumina, glass, potassium titanate, and aluminum borate.

14. The honeycomb structure according to claim 1, wherein the at least one honeycomb unit comprises plural honeycomb units bonded to each other by interposing adhesive layers.

15. The honeycomb structure according to claim 1, wherein the honeycomb structure comprises a single honeycomb unit.

16. The honeycomb structure according to claim 1, further comprising:
an outer peripheral coating layer formed on an outer surface of the honeycomb structure.

17. The honeycomb structure according to claim 1, wherein
a thickness of the walls varies continuously or discontinuously in each of the center area and the outer peripheral area.

18. The honeycomb structure according to claim 17, wherein the walls in the center area comprise a first wall and a second wall located closer to the center of the honeycomb structure than the first wall, a thickness of the second wall being larger than a thickness of the first wall.

19. The honeycomb structure according to claim 17, wherein the walls in the outer peripheral area comprise a third wall and a fourth wall located closer to the peripheral shape of the honeycomb structure than the third wall, a thickness of the fourth wall being smaller than a thickness of the third wall.

20. The honeycomb structure according to claim 1,
wherein a thickness of the walls is substantially constant in each of the center area and the outer peripheral area, and
wherein a density of the through holes in the center area is greater than a density in the outer peripheral area.

21. The honeycomb structure according to claim 1, wherein a ratio of the first aperture ratio in the outer peripheral area to the second aperture ratio in the center area is in a range from approximately 1.2 to approximately 2.0.

22. The honeycomb structure according to claim 7, wherein the zeolite has an ion-exchanged amount in a range from approximately 1.0 wt % to approximately 10.0 wt %.

23. The honeycomb structure according to claim 9, wherein an average particle diameter of the inorganic particles other than zeolite is in a range from approximately 0.5 μm to approximately 10 μm.

24. The honeycomb structure according to claim 9, wherein the inorganic particles other than zeolite comprise secondary particles.

25. The honeycomb structure according to claim 24, wherein a ratio of an average particle diameter of secondary particles of the zeolite to an average particle diameter of the secondary particles of the inorganic particles other than zeolite is equal to or less than approximately 1.

26. The honeycomb structure according to claim 9, wherein a content of the inorganic particles other than zeolite in the at least one honeycomb unit is in a range from approximately 3 wt % to approximately 30 wt %.

27. The honeycomb structure according to claim 1, wherein a content of inorganic binder in the at least one honeycomb unit is in a range from approximately 5 wt % to approximately 30 wt %.

28. The honeycomb structure according to claim 12, wherein an aspect ratio of the inorganic fibers is in a range from approximately 2 to approximately 1000.

29. The honeycomb structure according to claim 12, wherein a content of inorganic fibers in the at least one honeycomb unit is in a range from approximately 3 wt % to approximately 50 wt %.

30. The honeycomb structure according to claim 1, wherein a density of the through holes in the cross section perpendicular to the longitudinal direction of the at least one honeycomb unit is in a range from approximately 15.5 units/cm² to approximately 124 units/cm².

31. The honeycomb structure according to claim 1, wherein a thickness of each of the walls is in a range from approximately 0.10 mm to approximately 0.50 mm.

32. The honeycomb structure according to claim 1, wherein the at least one honeycomb unit is manufactured by being fired at a temperature in a range from approximately 600° C. to approximately 1200° C.

33. The honeycomb structure according to claim 14, wherein a cross-sectional area perpendicular to the longitudinal direction of the at least one honeycomb unit is in a range from approximately 5 cm² to approximately 50 cm².

34. The honeycomb structure according to claim 14, wherein the honeycomb structure is manufactured by assembling the plural honeycomb units and cutting the plural honeycomb units.

35. The honeycomb structure according to claim 14, wherein the honeycomb structured is manufactured by bonding the plural honeycomb units comprising a substantially fan-shaped honeycomb unit and a substantially squared honeycomb unit in the cross section.

36. The honeycomb structure according to claim 1, wherein the honeycomb structure is so constructed to be used in an SCR system for NOx conversion.
